(19) United States
(12) Patent Application Publication
(10) Pub. No.: US 2004/0039806 A1
(43) Pub. Date: Feb. 26, 2004

(54) METHODS AND SYSTEMS FOR THE SYNCHRONIZED RECORDING AND READING OF DATA COMING FROM A PLURALITY OF TERMINAL DEVICES

(76) Inventor: Bertrand MIRAS, Bagneux (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/248,211

(22) Filed: Dec. 27, 2002

(30) Foreign Application Priority Data
Oct. 26, 2001 (FR) 0113900

(51) Int. Cl. G06F 15/173

(52) U.S. Cl. 709/223

(57) ABSTRACT

The present invention relates to techniques for the synchronized recording and playback of data coming from a plurality of terminal devices. Each terminal device (E₁, E₂, E₃, E₄, E₅, E₆) sends out data on a communications line (L₁, L₂, L₃, L₄, L₅, L₆) that is proper to it. The transmission on this line may be synchronous or asynchronous, parallel or serial, according to any unacknowledged protocol. The disclosed recording system (S₁) comprises at least: (a) one or more routers (M₁, M₂) connected to the communications lines, each communications line being connected to a single router, for the sampling at constant frequency of the signal (PDU, NS) on each communications line, even when there are no transmitted data, so that each terminal device has a corresponding stream of sampled bits; (b) a local area network (RE) to which the routers are connected and on which the routers send out the streams of sampled bits; (c) a central processing unit (UC) connected to said local area network for the recording, in one or more binary files, of said bit streams sent out by said routers on said network. The invention can be applied especially to the testing of air traffic management systems, the terminal devices being radars in this application.

### BACKGROUND OF THE INVENTION

The present invention relates to techniques for the synchronized recording and playback of data coming from a plurality of terminal devices. It can be applied especially to tests on air traffic management systems, the terminal devices being radars in this application.

In order to test air traffic management systems, data from the different radar channels can be recorded with DAT analyzers (magnetic tapes) for example. Once these data are recorded, they are played back on a test platform. However, the DAT analyzers cannot record the data evenly enough to ensure constant playback speed. This is because the magnetic tape drive system is a mechanical system that inevitably induces drifts (advances or delays) during the recording. Furthermore, since the DAT analyzers were initially designed to record sound waves, their bandwidth is (20 kbps). It is therefore not possible to record a large number of channels simultaneously, or even to record one channel with a high bit rate (2 Mbps). This bandwidth problem could be overcome by using several DAT analyzers in parallel. However, there is then a problem of synchronization between a plurality of analyzers. Furthermore, a system of this kind based on parallel-connected DAT analyzers is not flexible in its use: it is not possible to move forward or back in the recording while at the same time maintaining synchronization between the analyzers.

There is another type of analyzer that carries out a decoding of the communications protocol. This system makes it possible to record only the useful data. The bandwidth needed for the recording is therefore limited. However, these analyzers can work only with known communications protocols. Now, radars send out data according to specific protocols. This type of analyzer is not appropriate because it is limited to the known protocols. Furthermore, the recorded data must be dated to enable synchronization. This dating is done by adding time markers to the recorded data. This may give rise to substantial volumes of data and/or to imprecise synchronization. Furthermore, it is not easy to play back one part of the recorded data because it is necessary to go through all the recorded data and read the time markers.

Through its characteristics, as described and claimed here below, the invention seeks to resolve the above-mentioned problems. It seeks especially to achieve the parallel recording and playback of data coming from a plurality of terminal devices, in a synchronized way, without depending on the communications protocol.

### SUMMARY OF THE INVENTION

To meet this goal and obtain other advantages that will appear more clearly here below, it is an object of the invention especially to provide a method for the recording of data from a plurality of terminal devices, each terminal device sending out data on a communications line that is proper to it, the transmission on this line being possibly synchronous or asynchronous, parallel or serial, according to any unacknowledged protocol, wherein:

(a) the signal on each communications line is sampled at constant frequency, even when there are no transmitted data, so that each terminal device has a corresponding stream of sampled bits;

(b) the streams of sampled bits are sent on a local area network;

(c) the bit streams sent out on said network are recorded in one or more binary files with a central processing unit connected to said local area network.

For the implementation of the recording method thus defined, an object of the invention is also a system for the recording of data coming from a plurality of terminal devices, each terminal device sending out data on a communications line that is proper to it, the transmission on this line being possibly synchronous or asynchronous, parallel or serial, according to any unacknowledged protocol, wherein the system comprises at least:

(a) one or more routers connected to the communications lines, each communications line being connected to a single router, for the sampling at constant frequency of the signal on each communications line, even when there is no transmitted data, so that each terminal device has a corresponding stream of sampled bits;

(b) a local area network to which the routers are connected and on which the routers send out the streams of sampled bits;

(c) a central processing unit connected to said local area network for the recording, in one or more binary files, of said bit streams sent out by said routers on said network.

To meet this goal, an object of the invention is also a data-reading method wherein, with the data being recorded by the implementation of the recording method defined here above:

(a) the bit streams recorded on a playback local area network (RE′), having the same topology as the local area network (RE) used during the implementation of the recording method, are sent out simultaneously;

(b) the bit streams sent out on the local playback network (RE′) are retransmitted on the playback communications lines, the playback communications lines being similar to the communications lines (L₁, L₂, L₃, L₄, L₅, L₆) connected to the terminal devices (E₁, E₂, E₃, E₄, E₅, E₆), so as to produce, from each retransmitted bit stream, a signal at a frequency that is a multiple of the sampling frequency.

For the implementation of the reading method thus defined, an object of the invention is also a data-reading system wherein, to read the data recorded by the implementation of the recording method defined here above, the system comprises at least:

(a) a playback local area network (RE′) having the same topology as the local area network (RE) used during the implementation of the recording method;

(b) a central processing unit (UC′), connected to the playback local area network, to send out the recorded bit streams on the playback local area network;

(c) one or more routers (M′1, M′2), connected to the playback local area network and designed to be connected to playback communications lines for the re-transmission of the bit streams sent out on the playback local area network (RE′) on the playback communications lines, the playback communications lines being similar to the communications lines (L₁, L₂, L₃, L₄, L₅, L₆) connected to the terminal devices (E₁, E₂, E₃, E₄, E₅, E₆) so as to produce, from each retransmitted bit stream, a signal at a frequency that is a multiple of the sampling frequency.

In the context of advantageous embodiments, in order to improve the open-ended character of the recording and reading systems thus defined, the invention is expressed by the fact that the local area network of the recording system and the playback local area network is an Ethernet network.

In the context of advantageous embodiments, in order to improve the reliability of the methods and systems thus defined, according to the invention, the bit streams are sent out on the (recording or playback) local area network according to an acknowledged protocol. This acknowledged protocol guarantees non-loss of information.

The main advantages of the invention are that it can be implemented by using tried and tested components available in the market. This makes it economical, simple to implement and reliable. It is also ergonomic inasmuch as it enables the partial playback of the data in a simple way.

### BRIEF DESCRIPTION OF DRAWINGS

The invention shall now be described in a more detailed manner in the context of a special exemplary practical embodiment. In this description, reference shall be made to the figures of the appended drawings, of which:

FIG. 1 is a block diagram of an exemplary recording system according to the invention;

FIG. 2 is a block diagram according to the TCP/IP four-layer model of representation, showing an exemplary link between a terminal device and the recording system;

FIG. 3 is a block diagram showing an exemplary shaping of the signal recorded on a line, for transmission according to a TCP/IP communications protocol on the local area network;

FIG. 4 is a diagrammatic view of an exemplary implementation of a round robin recording method;

FIG. 5 is a block diagram showing an exemplary reading system according to the invention;

FIGS. 6 and 7 are diagrammatic views of an exemplary use of the invention in which a recording system such as the one shown FIG. 1, and a reading system such as the one shown in FIG. 5, are connected to the internet.

### DETAIL DESCRIPTION

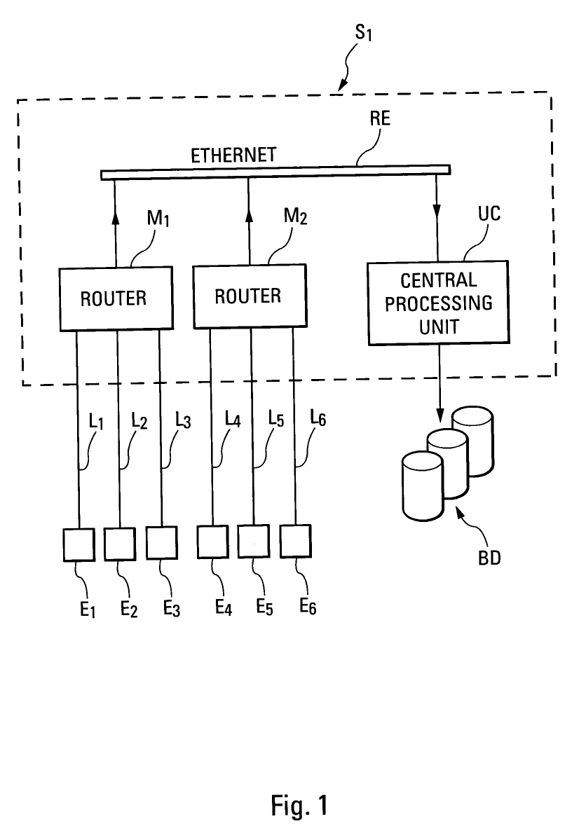

Reference is now made to FIG. 1. In this example, there are six terminal devices E₁, E₂, E₃, E₄, E₅, E₆. Each terminal device E₁, E₂, E₃, E₄, E₅, E₆ sends out data on a communications line L₁, L₂, L₃, L₄, L₅, L₆ of its own. The terminal devices may be radars, the communications lines may be HDLC serial lines for example. Naturally, the communications lines may also be parallel lines. A recording system S₁ according to the invention is connected to these communications lines. The recording unit S₁ has at least one router, one central processing unit UC and one local area network RE. It has, for example, two routers M₁, M₂. Each communications line is connected to a single router of the system S₁. The router M₁ may be connected to the lines L₁ to L₃. The router M₂ may be connected to the lines L₄ to L₆. The routers M₁, M₂ and the central processing unit UC are furthermore connected to the local area network RE. The routers M₁, M₂ sample the signal on each communications line, and send this signal out on the local area network RE to the central processing unit. The central processing unit UC records the data received in binary files BD. Advantageously, each communications line has at least one binary file associated with it. The name of this binary file makes it possible to find the associated communications line.

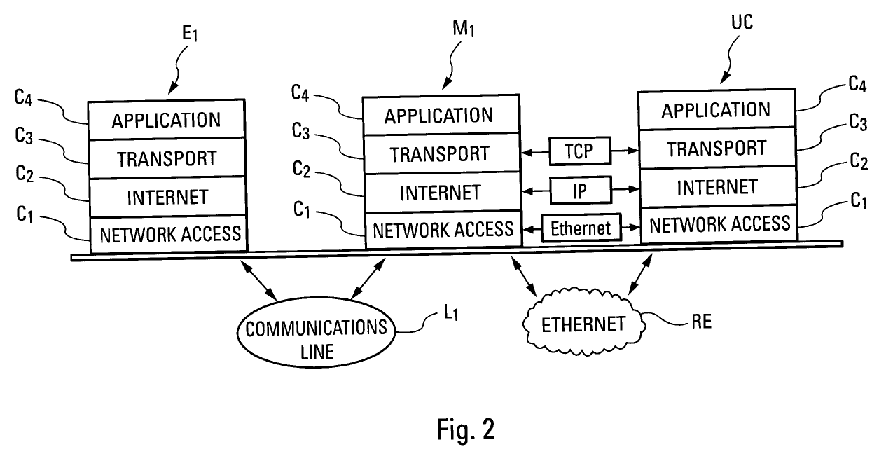

Reference is now made to FIG. 2. This figure gives a view, in a TCP/IP model, of the link between the device E₁ and the router M₁ on the one hand and between the router M₁ and the central processing unit UC on the other hand. Naturally, this description can be applied also to links with other terminal devices, as well as with the other router M₂.

It may be recalled that the TCP/IP model is constituted by four layers:

the first layer C₁ is the network access layer. This layer is equivalent to the layers 1 (physical layer) and 2 (link layer) of the OSI model.

The second layer C₂ is the internet layer. This layer is equivalent. to the layer 3 (internet layer) of the OSI model.

The third layer C₃ is the transport layer. This layer is equivalent to the layers 4 (transport layer), 5 (session layer) and 6 (presentationof the OSI model.

The fourth layer C₄ is the application layer. This layer is equivalent to the layer 7 (application layer) of the OSI model.

The terminal device E₁ sends out data on the communications line L₁ according to a protocol not known to the router M₁. The router M₁ does not decode this protocol. Hence no common communications protocol can be seen in the TCP/IP model between the terminal device E1 and the router M1, even in the first layer C₁. The protocol according to which the terminal device E₁ sends data on the line L₁ may be any unacknowledged protocol. In other words, this is a one-way protocol. It may be standardized or proprietary. Transmission on this line L₁ may be synchronous or asynchronous. The only constraint is that of the compatibility of the physical medium between the terminal device E₁ and the router M₁. The electric format may be any format whatsoever, for example the RS232, RS485, EIA530, EIA530-A or V35 format. The entire signal on the line L1 is sampled by the router M₁ without the decoding of the protocol. In other words, this signal is converted into a bit stream by the router M₁.

The router M1 sends out the stream of sampled bits on the local area network RE. Advantageously, the local area network RE is an Ethernet network. This makes it possible to connect as many routers as necessary to record the data of any number of terminal devices. This therefore fosters the open-ended character of the reading system S₁.

Advantageously, the bit stream is sent out by the router M₁ on the local area network RE according to an acknowledged protocol. This makes the transmission to the central processing unit UC reliable, namely without any loss of information.

Advantageously, the communications protocol between the router M1 and the central processing unit UC may be a connection-oriented secured protocol, i.e. a reliable transport protocol.

Advantageously, this connection-oriented secured protocol may be the TCP/IP protocol. Thus, each communications line has an associated IP address. This IP address may be a parameter of the recording program of the central processing unit UC. The TCP/IP protocol may, for example, be subdivided at the level of the different layers of the TCP/IP model as follows:

at the network access layer C₁, the Ethernet protocol;

at the internet layer C₂, the IP internet protocol;

at the transport layer C₃, the TCP protocol.

The main functions of the router M₁ are therefore, especially, the sampling of the signal on L₁ to obtain a bit stream, the conversion of this bit stream into the TCP/IP protocol, and the relaying of this bit stream to the central processing unit UC.

There are commercially available routers that can be used to carry out these functions. For example, we may cite a range of products under the registered mark LINES or Interface Node for External Systems”. These routers, which are modular type routers, are designed to enable routing among incoming or outgoing serial lines and the Ethernet. They process the standard serial lines such as, for example, the HDLC or BSC lines, as well as dedicated lines such as, for example, those using special radar information transmission protocols.

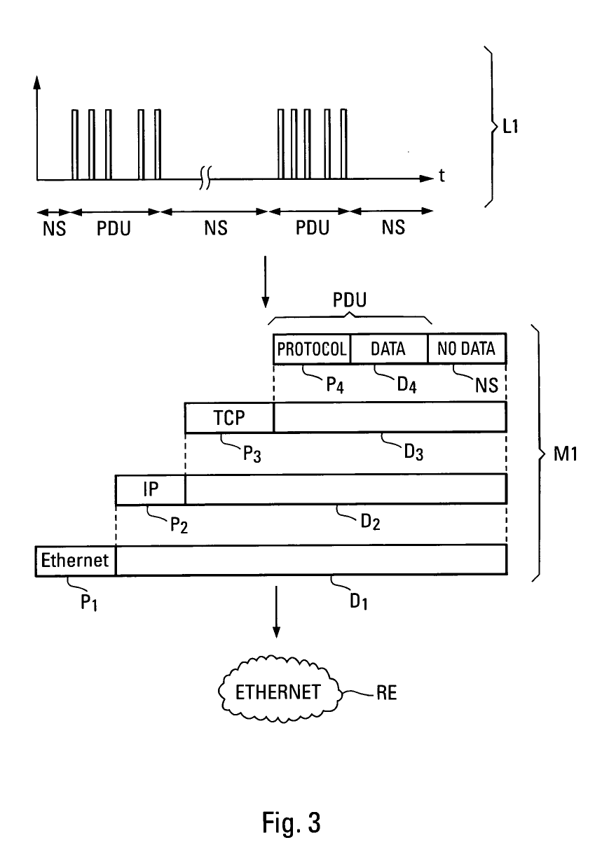

Reference is now made to FIG. 3. The signal sampled on the communications line L₁ comprises first time zones PDU where data are effectively sent out by the terminal device E₁, and second time zones NS where no data is sent out. The first zones PDU contain data sent out by the terminal device E₁ according to a protocol proper to this device. These data are called protocol data units. The protocol data units PDU contain data of two kinds D₄ and P₄:

the first data D₄ are the data really sent out;

the second data P₄ consist of protocol control information P₄;

The second data P₄ indicate the length of the data sent out D₄, and make it possible to correct errors for example. They are designed to be interpreted and used by a receiver device. By contrast, the router M₁ does not interpret these data. It samples the signal PDU, NS present on the line L₁ at a constant frequency, even when there are no data NS sent out by the terminal device E₁. The entire sampled signal P₄, D₄, NS forms a bit stream D₃.

This is especially valuable for data from radar measurements, because such data has few gaps, namely cases where there is a lack of transmitted data NS. The encoding of a time marker with the data would lead to an increase in the volume of data.

To synchronies the sampling of the signal, it is possible to use a physical clock such as that of the router for example. This enables the use of an absolute time reference for the sampling, and is hence common to the different communications lines. In other words, by using physical clocks, it is possible to synchronize the recording of signals on the different communication lines.

Advantageously, the sampling frequencies are determined as follows:

If the terminal device sends out data synchronously (synchronous protocol), a sampling frequency equal to the transmission frequency of this terminal device is used.

If the terminal device sends out data asynchronously (asynchronous protocol), a sampling frequency equal to the maximum bit rate of the communications line, expressed in bits per second, is used. In this case, the router sub-samples the signal.

In other words, for each terminal device sending out data synchronously, the sampling frequency is equal to the transmission frequency of said terminal device, and for the other terminal devices the sampling frequency is equal to the maximum bit rate of the communications line.

The different sampling frequencies may be recorded in a configuration file of the routers. This configuration file may be parametrized before the recording is started. It contains for example:

the electrical mode of the communications line;

the transmission speed;

the clock mode, namely internal clock signal or external clock signal.

The internal clock signal is given by the router. The external clock signal may be given by the terminal.

For an HDLC serial communications line on which the data are sent out synchronously, the sampling frequency may be equal to 2 10⁶ bits per second (i.e. 2 Mbps). If the clock drift is 10⁻⁹ (drift equivalent to a 1s advance or delay every 10⁹s), there is a resynchronization by one bit every 20 minutes. This performance is very appreciably better than that of the DAT analyzers.

In order to send the bit stream D₃ in the TCP/IP protocol, data on protocol control are added during the passage from one layer to another. For the passage from the layer C₃ to the layer C₂, the router M₁ adds TCP protocol control information (reference P₃ in the figure) to the bit stream D₃, thus forming new data D₂. For the passage from the layer C₂ to the layer C₁, the router M₁ adds IP protocol control information (reference P₂ in the figure) to the new data D₂, thus forming new data D₁. For the passage from the layer C₁ to the physical medium of the Ethernet, the router M₁ adds Ethernet protocol control information (reference P₁ in the figure) to the new data D₁.

The bit stream D₃ is received by the central processing unit UC which decodes the protocol P₁, P₂, P₃ control information. The bit stream D₃ is then recorded in one or more binary files BD.

Naturally, the same explanations can be applied to the other terminal devices E₂ to E₆ and to the other router M₂. Each terminal device therefore has a corresponding bit stream that is sent to the central processing unit UC on a different (physical or software) channel.

The invention enables the playback of any part whatsoever of the recorded sequence. To start the playback from a specified time, it is enough to count the number of bits at which the reading must start. The conversion between a time and a number of bits is done by using the sampling frequencies (which are constant throughout the recording duration). These sampling frequencies can be read in the configuration file of the routers for example. The invention furthermore enables the looped playback of a part of the sequence. This of course can be done only by using a DAT analyzer.

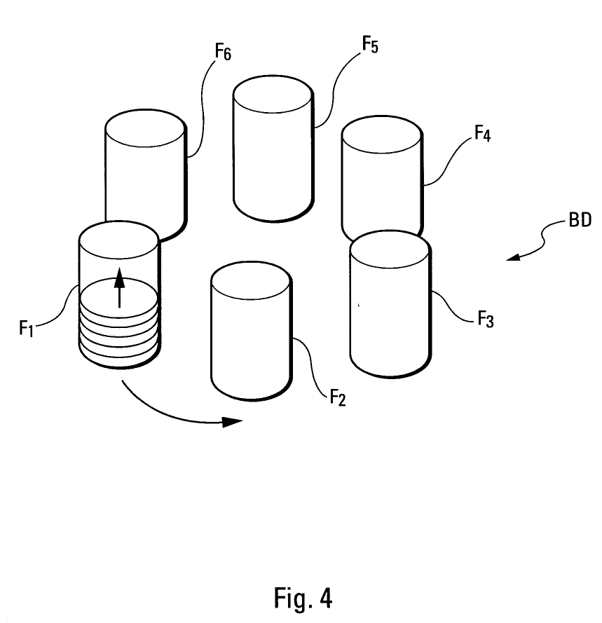

Reference is now made to FIG. 4. Advantageously, the central processing unit UC implements a round robin recording method to record the bit streams sent out on the local area network RE. This round robin recording consists in recording the bit streams in a specified number of fixed-size binary files F₁, F₂, F₃, F₄, F₅, F₆. When one file F₁ is full, the data are recorded in the next file. If all the files are filled, the recording continues in the first file, with the overwriting of the earliest data. This enables recording for an unlimited time and the preservation, for example, of only the last times of recording (the recording is stopped as soon as an anomaly is detected). This method has the advantage of speed and easy implementation as compared with a standard direct-access writing method.

Advantageously, each bit stream can be recorded in a different binary file to facilitate differentiated access to the bit streams.

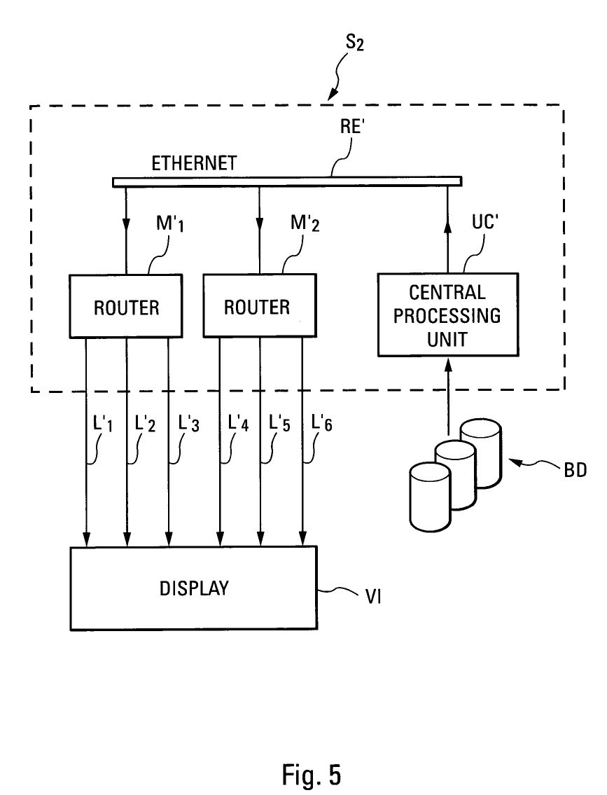

Reference is now made to FIG. 5. The data flows recorded in the binary files may be read by a reading system S₂. This reading system S₂ is designed to be connected to playback communications lines L′₁, L′₂, L′₃, L′₄, L′₅, L′₆. The playback communications lines are similar to the communications lines connected to the terminal devices during the recording. The reading system S₂ sends out the recorded signal on these lines in a synchronized way.

The reading system S₂ comprises at least one playback local area network RE′. This local area network RE′ has the same topology as the network RE. In other words, it has a main node formed by a central processing node UC′, and secondary nodes formed by the ends of the playback communications lines connected to the local area network RE′.

The reading system S₂ furthermore comprises at least one router. It has, for example, two routers M′₁ and M′₂. These routers are connected to the playback local area network RE′. They are designed to be connected to the playback communications lines. Each playback communications line is connected to only one router. For example, the router M′₁ may be connected to the lines L′₁, L′₂, L′₃ the router M′₂ may be connected to the lines L′₄, L′₅, L′₆.

The central processing unit UC′ sends out the recorded bit streams simultaneously on the playback local area network RE′. These bit streams are received by the routers M′₁, M′₂ and re-transmitted on the lines L′₁ to L′₆ so as to produce a signal on each playback communications line from each re-transmitted bit stream. These signals are produced in a synchronized way. To this end, on each playback communications line, the signal is produced at a frequency that is a multiple of the sampling frequency. For real-time playback (where the playback speed is the same as the recording speed), a signal at the same frequency as the sampling frequency is produced on each line.

To send out the recorded bit streams on the local area network RE′, the central processing unit UC′ may set up simultaneous TCP/IP connections with the routers. The central processing unit sends out the bit streams to the routers. The frequency at which a bit stream is transmitted through the central processing unit UC′ is greater than the frequency of transmission of this bit stream on the playback communication lines. Each bit stream is stored temporarily in a buffer memory. The bit streams gradually release these buffer memories as and when they are retransmitted in the form of signals on the playback communication lines.

Advantageously, the central processing unit UC′ and the routers communicate with each other in order to control the filling of the buffer memories. Controlling the filling of a buffer memory consists of the following:

preventing the memory from being saturated;

preventing the memory from being completely emptied.

In other words, since the transmission frequency is greater than the re-transmission frequency, each bit stream is temporarily stored in a buffer memory before being retransmitted, the filling of the buffer memory being controlled.

To prevent the saturation of a buffer memory, a signal is sent from the router concerned to the central processing unit UC′ as soon as a maximum filling threshold has been reached. This maximum filling threshold may, for example, be equal to 90% of the capacity of the buffer memory. At reception of the signal, the central processing unit UC′ stops the sending, to this router, of the bit stream corresponding to this buffer memory.

To prevent the total emptying of a buffer memory, a signal is sent from the router concerned to the central processing unit UC′ as soon as a minimum filling threshold has been reached. This minimum filling threshold may, for example, be equal to 10% of the capacity of the buffer memory. At reception of the signal, the central processing unit UC′ resumes the sending, to this router, of the bit stream corresponding to this buffer memory.

The control of the filling of the buffer memory is optional. As an alternative, when a buffer memory is saturated for example, the non-stored data may be regularly retransmitted. In this way, the saturation of a buffer memory does not cause any loss of data. Furthermore, since the transmission is constant, the buffer memory can no longer be entirely emptied.

To send data in a synchronized way, namely to produce, on each playback communications line, a signal that is a multiple of the sampling frequency, the routers M′₁, M′₂ can implement a flow control method. Flow control is a method known to those skilled in the art.

Advantageously, in the same way as in the case of a recording S₁, the bit streams are sent out on the playback local area network according to an acknowledged transmission protocol.

Advantageously, in the same way as in the case of the recording system S₁, the bit streams are sent out on the playback local area network according to the TCP/IP protocol.

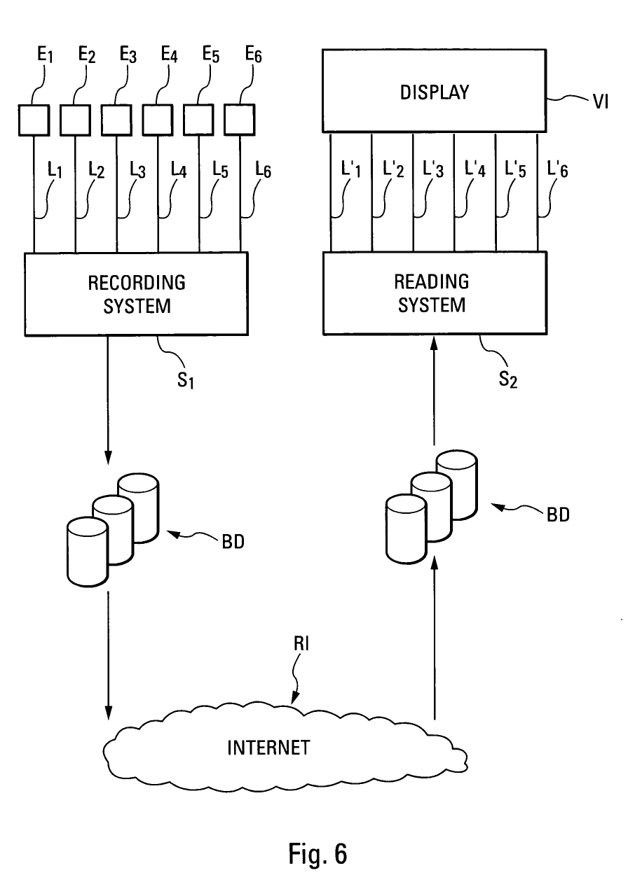

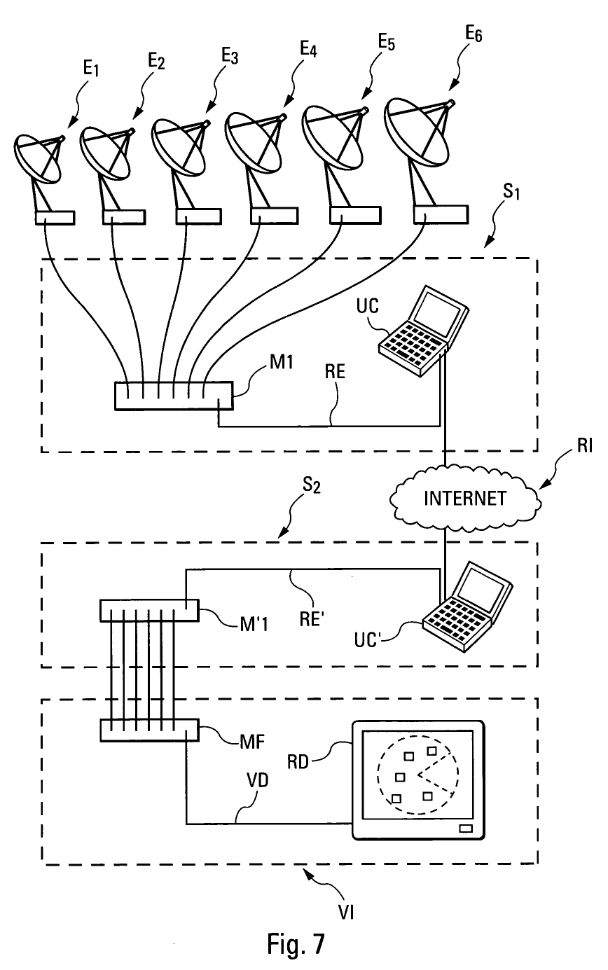

Reference is now made to FIGS. 6 and 7. The invention can be used to record data on a site and carry out tests on another site. The recording system S₁ may be, for example, in the vicinity of an air traffic control system. It is connected; for example, to six radars E₁, E₂, E₃, E₄, E₅, E₆. The reading system S₂ may, for example, be in the vicinity of a display system VI placed in a remote analysis center. The recording system produces a set of binary files BD. These files may be transmitted simply to the reading system S₂ through the internet RI for example.

In an advantageous practical embodiment, the central units UC, UC′ of the recording system S₁ and reading system S₂ respectively may be portable computers equipped with Ethernet cards. The routers may remain wired (with permanent links with the Ethernet network and the communications lines). It is then enough to connect these portable computers to the Ethernet. The implementation of the recording and reading systems may be very fast and very simple.

The output of the reading system S₂ is a set of playback communications lines. The display system may comprise, for example, a shaping device MF, a communications line VD sending out a video signal and a display signal RD. The shaping device MF may convert the signals of the playback communications lines into a video signal. This video signal is then transmitted on the communications line VD to the screen RD for the display of the radar blips.

Advantageously, the software programs present in the central processing units UC, UC′ for the implementation of the invention are in the JAVA language. This means that these software programs can work in any operating system.

The invention can be used to record the signals present on communications lines, without being limited to standardized or known protocols, for as many lines as necessary, without any limitation on frequency, whatever the transmission speed and the electrical mode. Furthermore, the invention enables the playback of all or part of these recorded signals, in a synchronous manner. It is also possible, within the framework of the invention, to use one and the same system to carry out both the recording and the reading.

In any case, although they are particularly advantageous, the special embodiments described are nevertheless non-exhaustive. There is a variety of alternative embodiments, relating especially to the details given by way of examples. These alternatives remain within the framework of the invention covered by the patent.

1. A method for the recording of data coming from a plurality of terminal devices, each terminal device sending out data on a communications line that is proper to it, the transmission on this line being possibly synchronous or asynchronous, parallel or serial, according to any unacknowledged protocol, wherein:
(a) the signal on each communications line is sampled at constant frequency, even when there are no transmitted data, so that each terminal device has a corresponding stream of sampled bits;
(b) the streams of sampled bits are sent on a local area network;
(c) the bit streams sent out on said network are recorded in one or more binary files with a central processing unit connected to said local area network.

2. A recording method according to the above claim, wherein the local area network is an Ethernet network.

3. A recording method according to any of the above claims, wherein the bit streams are sent out on the local area network to the central processing unit according to an acknowledged transmission protocol.

4. A recording method according to any of the above claims, wherein the bit streams are sent out on the local area network to the central processing unit according to the TCP/IP protocol.

5. A recording method according to any of the above claims, wherein the bit streams are sampled and sent out by one or more routers, each communications line being connected to only one router.

6. A recording method according to any of the above claims wherein, for each terminal device sending out data synchronously, the sampling frequency is equal to the transmission frequency of said terminal device and, for the other terminal devices, the sampling frequency is equal to the maximum bit rate of the communications lines.

7. A recording method according to any of the above claims, wherein the central processing unit implements a round-robin method to record said bit streams sent out on the network.

8. A system for the recording of data coming from a plurality of terminal devices, each terminal device sending out data on a communications line that is proper to it, the transmission on this line being possibly synchronous or asynchronous, parallel or serial, according to any unacknowledged protocol, wherein the system comprises at least:
(a) one or more routers connected to the communications lines, each communications line being connected to a single router, for the sampling at constant frequency of the signal on each communications line, even when there are no transmitted data, so that each terminal device has a corresponding stream of sampled bits;
(b) a local area network to which the routers are connected and on which the routers send out the streams of sampled bits;
(c) a central processing unit connected to said local area network for the recording, in one or more binary files, of said bit streams sent out by said routers on said network.

9. A recording system according to claim 8, wherein the local area network is an Ethernet network.

10. A recording system according to any of the claims 8 to 9, wherein the communications protocol of the local area network is an acknowledged protocol.

11. A recording system according to any of the claims 8 to 10, wherein the communications protocol of the local area network is the TCP/IP protocol.

12. A data-reading method wherein, with the data being recorded by the implementation of the recording method according to one of the claims 1 to 7:
(a) the bit streams recorded on a playback local area network, having the same topology as the local area network used during the implementation of the recording method, are sent out simultaneously;
(b) the bit streams sent out on the local playback network are retransmitted on the playback communications lines, the playback communications lines being similar to the communications lines connected to the terminal devices, so as to produce, from each retransmitted bit stream, a signal at a frequency that is a multiple of the sampling frequency.

13. A data-reading method according to the above claim wherein, for each bit stream, the transmission frequency being greater than the retransmission frequency, it is stored temporarily in a buffer memory before being retransmitted, the filling of the buffer memory being controlled.

14. A data-reading method according to the above claim wherein to produce a signal at a frequency that is a multiple of the sampling frequency on each playback communications line, a flow control method is implemented.

15. A reading method according to any of the claims 12 to 14, wherein the bit streams are sent out on the playback local area network according to an acknowledged transmission protocol.

16. A reading method according to any of the claims 12 to 15, wherein the bit streams are sent out on the playback local area network according to the TCP/IP protocol.

17. A data-reading system wherein, to read the data recorded by the implementation of the recording method according to any of the claims 1 to 6, the system comprises at least:
(a) a playback local area network having the same topology as the local area network used during the implementation of the recording method;
(b) a central processing unit connected to the playback local area network to send out the recorded bit streams on the playback local area network;
(c) one or more routers connected to the playback local area network and designed to be connected to playback communications lines for the re-transmission of the bit streams sent out on the playback local area network on the playback communications lines, the playback communications lines being similar to the communications lines connected to the terminal devices so as to produce, from each retransmitted bit stream, a signal at a frequency that is a multiple of the sampling frequency.

18. A data-reading system according to the above claim wherein, for each bit stream, the transmission frequency being greater than the retransmission frequency, it is stored temporarily in a buffer memory before being retransmitted, the filling of the buffer memory being controlled.

19. A data-reading system according to the above claim wherein, to produce a signal at a frequency that is a multiple of the sampling frequency on each playback communications line, a flow control method is implemented.

20. A reading system according to any of the claims 17 to 19, wherein the communications protocol of the playback local area network is an acknowledged transmission protocol.

21. A reading system according to any of the claims 17 to 20, wherein the communications protocol of the playback local area network is the TCP/IP protocol.
